(19) United States
(12) Patent Application Publication
(10) Pub. No.: US 2022/0020335 A1
(43) Pub. Date: Jan. 20, 2022

(54) DISPLAY PANEL AND DRIVING METHOD THEREOF

(71) Applicant: TCL China Star Optoelectronics Technology Co., Ltd., Shenzhen (CN)

(72) Inventor: Sheng HUANG, Shenzhen (CN)

(21) Appl. No.: 16/622,915

(22) PCT Filed: May 15, 2019
(86) PCT No.: PCT/CN2019/086968

§ 371 Date: Dec. 16, 2019

(30) Foreign Application Priority Data
Apr. 12, 2019 (CN) 201910294485.2

(51) Int. Cl. G09G 3/34; H05B 45/30

(52) U.S. Cl. CPC G09G 3/342; G09G 2320/0257; G09G 2310/08; H05B 45/30

(57) ABSTRACT

The present disclosure provides a display panel which comprises a backlight module, a first-part body, and a second-part body. The backlight module includes a control module, a first driving module, a second driving module, and light-emitting diodes. The control module includes a first control unit connected to the first driving module and a second control unit connected to the second driving module. The light-emitting diodes in the first-part body are electrically connected to the first driving module, and the light-emitting diodes in the second-part body are electrically connected to the second driving module.

### FIELD OF INVENTION

The present disclosure relates to the field of display technologies, and more particularly, to a display panel and a driving method thereof.

### BACKGROUND OF INVENTION

At present, time control boards (TCON) using local dimming technology is widely used in TV backlight driving solutions. The above system is mainly consisting of three parts: TCON, microcontroller units (MCU), and LED driver ICs. A TCON performs partitions sampling and brightness statistics on an input full-screen image and sends backlight driving data to an MCU in real time by a serial peripheral interface 1 (SPI1). Then, the MCU performs an addressing method via an SPI2 to locate an LED driver IC where a partition is assigned, and opens a specific output channel corresponding to the IC by a pulse width modulation (PWM) method. This way, a backlight and an image in a same partition can work together, thereby greatly reducing power consumption of backlights and improving contrast of displays.

However, current technical solutions are limited by ranges of chip selecting addresses of LED driver ICs. An MCU can drive only less than 30 LED driver ICs, which cannot meet products having higher backlight partition numbers.

Technical problem: current technical solutions are limited by ranges of chip selecting addresses of LED driver ICs. An MCU can drive only less than 30 LED driver ICs, which cannot meet products having higher backlight partition numbers.

### SUMMARY OF INVENTION

A display panel, comprises a backlight module and a display body. The backlight module comprises

a central control board;

a control module comprising a first control unit and a second control unit electrically connected to the central control board, wherein the central control board provides backlight driving data for the control module;

a first driving module electrically connected to the first control unit and a second driving module electrically connected to the second control unit, wherein the control module provides a control signal for the first driving module and the second driving module; and

a plurality of light-emitting diodes, wherein the display body has a light-emitting area, and the light-emitting diodes are disposed opposite to the light-emitting area;

wherein the display body comprises a first-part body and a second-part body, the light-emitting diodes corresponding to the first-part body are electrically connected to the first driving module, and the light-emitting diodes corresponding to the second-part body are electrically connected to the second driving module; the first-part body is a left half screen and the second-part body is a right half screen, or the first-part body is an upper half screen and the second-part body is a lower half screen.

Further, both the first driving module and the second driving module comprise at least one of driving units, the light-emitting area of the first-part body and the second-part body comprises a plurality of partitions corresponding to the driving units by one-to-one, and the light-emitting diodes corresponding to the partitions are electrically connected to the corresponding driving units.

Further, the central control board has a semiconductor field effect transistor, a clock signal line, a first pin, and a second pin, the first control unit is electrically connected to the first pin, the semiconductor field effect transistor, and the clock signal line, and the second control unit is electrically connected to the second pin, the semiconductor field effect transistor, and the clock signal line.

Further, the central control board provides a first chip selecting signal voltage to the first control unit by the first pin, and the central control board provides a second chip selecting signal voltage to the second control unit by the second pin.

A display panel, comprises a backlight module and a display body. The backlight module comprises

a central control board;

a control module comprising a first control unit and a second control unit electrically connected to the central control board, wherein the central control board provides backlight driving data for the control module;

a first driving module electrically connected to the first control unit and a second driving module electrically connected to the second control unit, wherein the control module provides a control signal for the first driving module and the second driving module; and

a plurality of light-emitting diodes, wherein the display body has a light-emitting area, and the light-emitting diodes are disposed opposite to the light-emitting area;

wherein the display body comprises a first-part body and a second-part body, the light-emitting diodes corresponding to the first-part body are electrically connected to the first driving module, and the light-emitting diodes corresponding to the second-part body are electrically connected to the second driving module.

Further, both the first driving module and the second driving module comprise at least one of driving units, the light-emitting area of the first-part body and the second-part body comprises a plurality of partitions corresponding to the driving units by one-to-one, and the light-emitting diodes corresponding to the partitions are electrically connected to the corresponding driving units.

Further, the central control board has a semiconductor field effect transistor, a clock signal line, a first pin, and a second pin, the first control unit is electrically connected to the first pin, the semiconductor field effect transistor, and the clock signal line, and the second control unit is electrically connected to the second pin, the semiconductor field effect transistor, and the clock signal line.

Further, the central control board provides a first chip selecting signal voltage to the first control unit by the first pin, and the central control board provides a second chip selecting signal voltage to the second control unit by the second pin.

Further, the first-part body is a left half screen and the second-part body is a right half screen.

Further, the first-part body is an upper half screen and the second-part body is a lower half screen.

The present disclosure further provides a driving method of a display panel. The method comprises following steps:

S10: a central control board providing backlight driving data for a first control unit and a second control unit;

S20: the first control unit providing a control signal to a first driving module and controlling light-emitting diodes corresponding to a first-part body to be turned on or turned off by the first driving module; and

S30: the second control unit providing the control signal to a second driving module and controlling the light-emitting diodes corresponding to a second-part body to be turned on or turned off by the second driving module.

Further, the step S10 comprises:

S11: in one frame scanning time, the central control board pulling down a first chip selecting signal provided by a first pin and sending the backlight driving data to the first control unit through a semiconductor field effect transistor and a clock signal line;

S12: the central control board pulling up the first chip selecting signal provided by the first pin and stopping enablement of the first control unit; and

S13: the central control board pulling down a second chip selecting signal provided by a second pin and sending the backlight driving data to the second control unit through the semiconductor field effect transistor and the clock signal line.

Further, both the first driving module and the second driving module comprise at least one of driving units, the light-emitting area of the first-part body and the second-part body comprises a plurality of partitions corresponding to the driving units by one-to-one, and the light-emitting diodes corresponding to the partitions are electrically connected to the corresponding driving units.

Further, the first-part body is a left half screen and the second-part body is a right half screen, or the first-part body is an upper half screen and the second-part body is a lower half screen.

Beneficial effect of the present disclosure: without increasing the number of central control boards, more drive modules can be controlled by more control modules through mounting at least two control modules on a same central control board. At the same time, a display body is divided into a number of parts, which have a same number as drive modules, and each part is driven by each corresponding drive module to increase the number of backlight partitions, thereby improving contrast, grayscale, and residual image of display panels for better visual effect.

### DESCRIPTION OF DRAWINGS

The accompanying figures to be used in the description of embodiments of the present disclosure or prior art will be described in brief to more clearly illustrate the technical solutions of the embodiments or the prior art. The accompanying figures described below are only part of the embodiments of the present disclosure, from which those skilled in the art can derive further figures without making any inventive efforts.

FIG. 1 is a schematic composition diagram of a backlight module according to an embodiment of the present disclosure.

FIG. 2 is a schematic diagram of a display body according to an embodiment of the present disclosure.

FIG. 3 is a schematic distribution diagram of partitions according to an embodiment of the present disclosure.

FIG. 4 is a schematic drive timing diagram of a backlight module according to an embodiment of the present disclosure.

FIG. 5 is a schematic diagram of another display body according to an embodiment of the present disclosure.

FIG. 6 is a driving flowchart of a display panel according to an embodiment of the present disclosure.

### DETAILED DESCRIPTION OF PREFERRED EMBODIMENTS

The embodiments of the present disclosure are described in detail hereinafter. Examples of the described embodiments are given in the accompanying drawings, wherein the identical or similar reference numerals constantly denote the identical or similar elements or elements having the identical or similar functions. In the description of the present disclosure, it should be understood that terms such as “upper”, “lower”, “front”, “rear”, “left”, “right”, “inside”, “outside”, “side”, as well as derivative thereof should be construed to refer to the orientation as described or as shown in the drawings under discussion. These relative terms are for convenience of description, do not require that the present disclosure be constructed or operated in a particular orientation, and shall not be construed as causing limitations to the present disclosure.

In current display panels, ranges of chip selecting addresses of control units are limited. A control module can drive only less than 30 control units, which cannot meet products having higher backlight partition numbers. The present disclosure can solve the above problem.

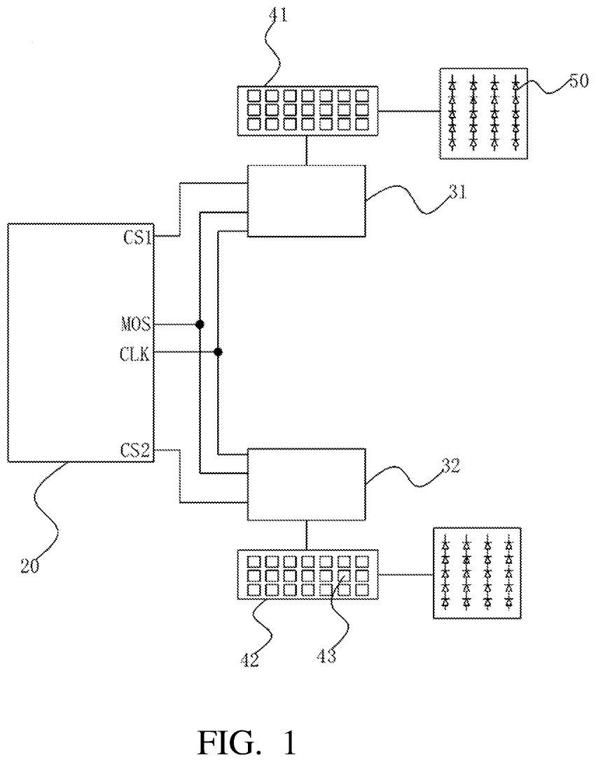

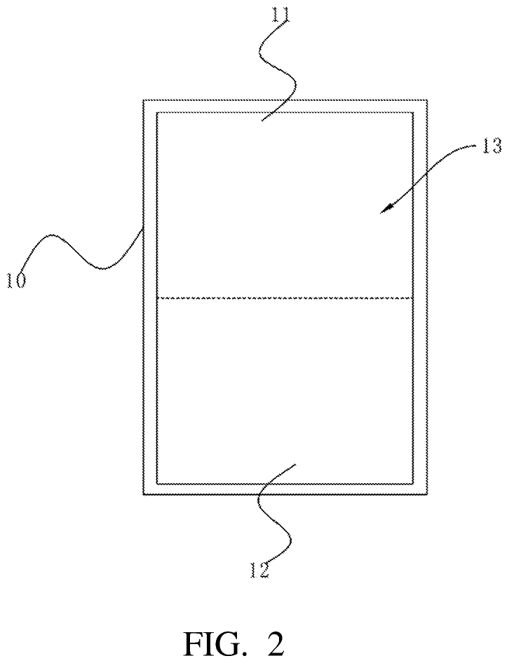

The present disclosure provides a display panel, as shown in FIG. 1 and FIG. 2. The display panel comprises a backlight module and a display body 10. The backlight module comprises a central control board 20, a control module, a first driving module 41, a second driving module 42, and a plurality of light-emitting diodes 50.

Wherein the central control board 20 has a semiconductor field effect transistor MOS, a clock signal line CLK, a first pin CS1, and a second pin CS2.

Wherein the control module comprises a first control unit 31 and a second control unit 32 electrically connected to the central control board 20.

Wherein, the first driving module 41 is electrically connected to the first control unit 31, and the second driving module 42 is electrically connected to the second control unit 32.

Wherein the display body 10 has a light-emitting area 13, and the light-emitting diodes 50 are disposed opposite to the light-emitting area 13.

Specifically, the central control board 20 provides backlight driving data for the control module, and after addressing and locating according to the received backlight driving data, the control module provides a control signal to the first driving module 41 and the second driving module 42.

Wherein, the display body 10 comprises a first-part body 11 and a second-part body 12, the light-emitting diodes 50 corresponding to the first-part body 11 are electrically connected to the first driving module 41, and the light-emitting diodes 50 corresponding to the second-part body 12 are electrically connected to the second driving module 42.

Without increasing the number of central control boards 20, more drive modules can be controlled by more control modules through mounting at least two control modules on a same central control board 20. At the same time, a display body 10 is divided into a number of parts, which have a same number as drive modules, and each part is driven by each corresponding drive module to increase the number of backlight partitions, thereby improving contrast, grayscale, and residual image of display panels for better visual effect.

Specifically, the first control unit 31 is electrically connected to the first pin CS1, the semiconductor field effect transistor MOS, and the clock signal line CLK, and the second control unit 32 is electrically connected to the second pin CS2, the semiconductor field effect transistor MOS, and the clock signal line CLK.

Specifically, the central control board 20 provides a first chip selecting signal voltage Cs1 to the first control unit 31 by the first pin CS1, and the central control board 20 provides a second chip selecting signal voltage Cs2 to the second control unit 32 by the second pin CS2.

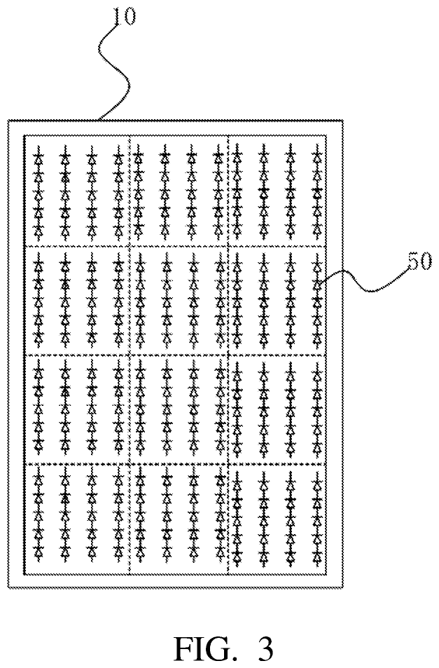

Specifically, referring to FIG. 1 and FIG. 3, both the first driving module 41 and the second driving module 42 comprise at least one of driving units 43, the light-emitting area 13 of the first-part body 11 and the second-part body 12 comprises a plurality of partitions corresponding to the driving units 43 by one-to-one, and the light-emitting diodes 50 corresponding to the partitions are electrically connected to the corresponding driving units 43.

Further, a number of the driving units 43 in a drive module ranges from 1 to 30, and a number of the partitions is greater than 500.

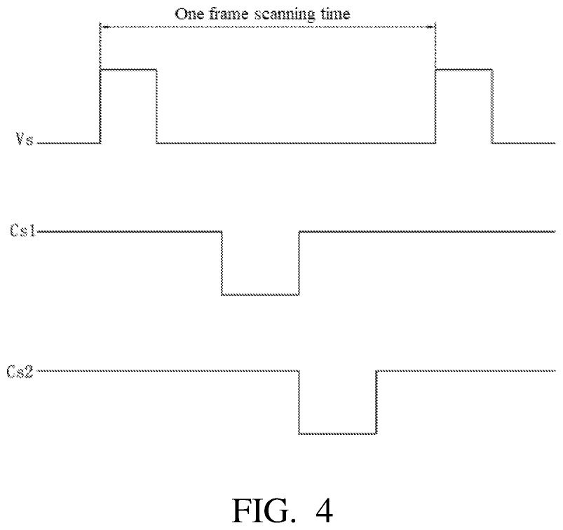

As shown in FIG. 4, the first control unit 31 and the second control unit 32 share a data line on the central control board 20. When the display panel emits light, after the central control board 20 performs partitions sampling and brightness statistics on an input full-screen image, in one frame scanning time, the central control board 20 firstly pulls down the first chip selecting signal voltage Cs1, selects the first control unit 31, and sends the backlight driving data in the partitions of the first-part body 11 to the first control unit 31 via the clock signal line CLK and the semiconductor field effect transistor MOS. Then, the central control board 20 pulls up the first chip selecting signal voltage Cs1, stops enablement of the first control unit 31, then pulls down the second chip selecting signal voltage Cs2, selecting the second control unit 32, and sending the backlight driving data in the partitions of the second-part body 12 to the second control unit 32 via the clock signal line CLK and the semiconductor field effect transistor MOS.

Wherein, after the first control unit 31 and the second control unit 32 receive corresponding backlight driving data, they will send these data to the driving units 43 corresponding to specific partitions, thereby driving the light-emitting diodes 50 in the specific partitions to emit light, and wait for a next frame of data renewal.

In an embodiment of the present disclosure, the first-part body 11 is an upper half screen and the second-part body 12 is a lower half screen.

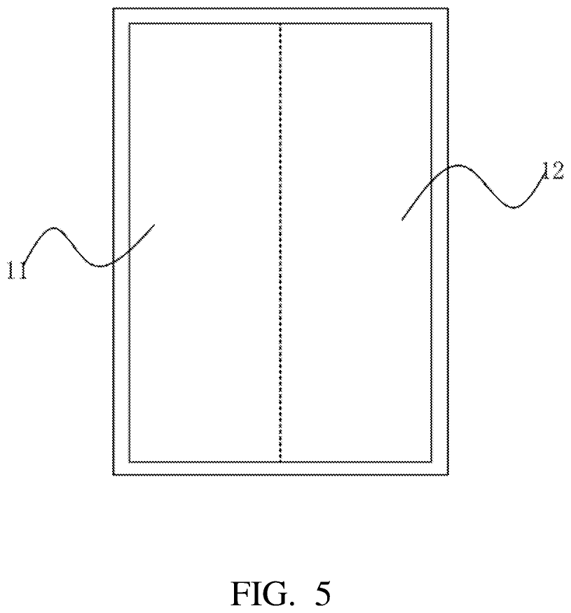

In another embodiment of the present disclosure, as shown in FIG. 5, the first-part body 11 is a left half screen and the second-part body 12 is a right half screen.

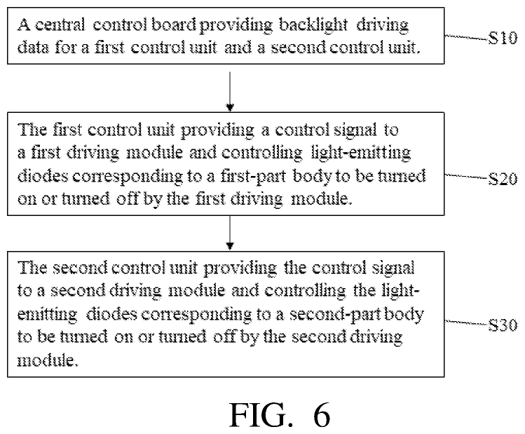

Based on the above display panel, the present disclosure further provides a driving method of a display panel. As shown in FIG. 6, the method comprises following steps:

S10: a central control board 20 providing backlight driving data for a first control unit 31 and a second control unit 32;

S20: the first control unit 31 providing a control signal to a first driving module 41 and controlling light-emitting diodes 50 corresponding to a first-part body 11 to be turned on or turned off by the first driving module 41;

S30: the second control unit 32 providing the control signal to a second driving module 42 and controlling the light-emitting diodes 50 corresponding to a second-part body 12 to be turned on or turned off by the second driving module 42.

Further, the step S10 comprises:

S11: in one frame scanning time, the central control board 20 pulling down a first chip selecting signal Cs1 provided by a first pin CS1 and sending the backlight driving data to the first control unit 31 through a semiconductor field effect transistor MOS and a clock signal line CLK;

S12: the central control board 20 pulling up the first chip selecting signal Cs1 provided by the first pin CS1 and stopping enablement of the first control unit 31; and

S13: the central control board 20 pulling down a second chip selecting signal Cs2 provided by a second pin CS2 and sending the backlight driving data to the second control unit 32 through the semiconductor field effect transistor MOS and the clock signal line CLK.

Specifically, both the first driving module 41 and the second driving module 42 comprise at least one of driving units 43, the light-emitting area 13 of the first-part body 11 and the second-part body 12 comprises a plurality of partitions corresponding to the driving units 43 by one-to-one, and the light-emitting diodes 50 corresponding to the partitions are electrically connected to the corresponding driving units 43.

Specifically, the first-part body 11 is a left half screen and the second-part body 12 is a right half screen, or the first-part body 11 is an upper half screen and the second-part body 12 is a lower half screen.

Beneficial effect of the present disclosure: without increasing the number of central control boards 20, more drive modules can be controlled by more control modules through mounting at least two control modules on a same central control board 20. At the same time, a display body 10 is divided into a number of parts, which have a same number as drive modules, and each part is driven by each corresponding drive module to increase the number of backlight partitions, thereby improving contrast, grayscale, and residual image of display panels for better visual effect.

The present disclosure has been described with a preferred embodiment thereof. The preferred embodiment is not intended to limit the present disclosure, and it is understood that many changes and modifications to the described embodiment can be carried out without departing from the scope and the spirit of the disclosure that is intended to be limited only by the appended claims.

1. A display panel, comprising a backlight module and a display body, the backlight module comprising:
a central control board;
a control module comprising a first control unit and a second control unit electrically connected to the central control board, wherein the central control board provides backlight driving data for the control module;
a first driving module electrically connected to the first control unit and a second driving module electrically connected to the second control unit, wherein the control module provides a control signal for the first driving module and the second driving module; and
a plurality of light-emitting diodes, wherein the display body has a light-emitting area, and the light-emitting diodes are disposed opposite to the light-emitting area;
wherein the display body comprises a first-part body and a second-part body, the light-emitting diodes corresponding to the first-part body are electrically connected to the first driving module, and the light-emitting diodes corresponding to the second-part body are electrically connected to the second driving module, the first-part body is a left half screen and the second-part body is a right half screen, or the first-part body is an upper half screen and the second-part body is a lower half screen.

2. The display panel according to claim 1, wherein both the first driving module and the second driving module comprise at least one of driving units, the light-emitting area of the first-part body and the second-part body comprises a plurality of partitions corresponding to the driving units by one-to-one, and the light-emitting diodes corresponding to the partitions are electrically connected to the corresponding driving units.

3. The display panel according to claim 1, wherein the central control board has a semiconductor field effect transistor, a clock signal line, a first pin, and a second pin, the first control unit is electrically connected to the first pin, the semiconductor field effect transistor, and the clock signal line, and the second control unit is electrically connected to the second pin, the semiconductor field effect transistor, and the clock signal line.

4. The display panel according to claim 3, wherein the central control board provides a first chip selecting signal voltage to the first control unit by the first pin, and the central control board provides a second chip selecting signal voltage to the second control unit by the second pin.

5. A display panel, comprising a backlight module and a display body, the backlight module comprising:
a central control board;
a control module comprising a first control unit and a second control unit electrically connected to the central control board, wherein the central control board provides backlight driving data for the control module;
a first driving module electrically connected to the first control unit and a second driving module electrically connected to the second control unit, wherein the control module provides a control signal for the first driving module and the second driving module; and
a plurality of light-emitting diodes, wherein the display body has a light-emitting area, and the light-emitting diodes are disposed opposite to the light-emitting area;
wherein the display body comprises a first-part body and a second-part body, the light-emitting diodes corresponding to the first-part body are electrically connected to the first driving module, and the light-emitting diodes corresponding to the second-part body are electrically connected to the second driving module.

6. The display panel according to claim 5, wherein both the first driving module and the second driving module comprise at least one of driving units, the light-emitting area of the first-part body and the second-part body comprises a plurality of partitions corresponding to the driving units by one-to-one, and the light-emitting diodes corresponding to the partitions are electrically connected to the corresponding driving units.

7. The display panel according to claim 5, wherein the central control board has a semiconductor field effect transistor, a clock signal line, a first pin, and a second pin, the first control unit is electrically connected to the first pin, the semiconductor field effect transistor, and the clock signal line, and the second control unit is electrically connected to the second pin, the semiconductor field effect transistor, and the clock signal line.

8. The display panel according to claim 7, wherein the central control board provides a first chip selecting signal voltage to the first control unit by the first pin, and the central control board provides a second chip selecting signal voltage to the second control unit by the second pin.

9. The display panel according to claim 5, wherein the first-part body is a left half screen and the second-part body is a right half screen.

10. The display panel according to claim 5, wherein the first-part body is an upper half screen and the second-part body is a lower half screen.

11. A driving method of a display panel, comprising following steps:
S10: a central control board providing backlight driving data for a first control unit and a second control unit;
S20: the first control unit providing a control signal to a first driving module and controlling light-emitting diodes corresponding to a first-part body to be turned on or turned off by the first driving module; and
S30: the second control unit providing the control signal to a second driving module and controlling the light-emitting diodes corresponding to a second-part body to be turned on or turned off by the second driving module.

12. The driving method of the display panel according to claim 11, wherein the step S10 comprises:
S11: in one frame scanning time, the central control board pulling down a first chip selecting signal provided by a first pin and sending the backlight driving data to the first control unit through a semiconductor field effect transistor and a clock signal line;
S12: the central control board pulling up the first chip selecting signal provided by the first pin and stopping enablement of the first control unit; and
S13: the central control board pulling down a second chip selecting signal provided by a second pin and sending the backlight driving data to the second control unit through the semiconductor field effect transistor and the clock signal line.

13. The driving method of the display panel according to claim 12, wherein both the first driving module and the second driving module comprise at least one of driving units, a light-emitting area of the first-part body and the second-part body comprises a plurality of partitions corresponding to the driving units by one-to-one, and the light-emitting diodes corresponding to the partitions are electrically connected to the corresponding driving units.

14. The driving method of the display panel according to claim 11, wherein the first-part body is a left half screen and the second-part body is a right half screen, or the first-part body is an upper half screen and the second-part body is a lower half screen.
